(19) United States
(12) Patent Application Publication
(10) Pub. No.: US 2023/0216617 A1
(43) Pub. Date: Jul. 6, 2023

(54) METHOD AND DEVICE IN NODES USED FOR WIRELESS COMMUNICATION

(71) Applicants: Lu WU, SHANGHAI (CN); Xiaobo ZHANG, SHANGHAI (CN)

(72) Inventors: Lu WU, SHANGHAI (CN); Xiaobo ZHANG, SHANGHAI (CN)

(73) Assignee: SHANGHAI TUILUO COMMUNICATION TECHNOLOGY PARTNERSHIP (LIMITED PARTNERSHIP), SHANGHAI (CN)

(21) Appl. No.: 18/083,574

(22) Filed: Dec. 19, 2022

(30) Foreign Application Priority Data
Dec. 31, 2021 (CN) 202111660528.8

(51) Int. Cl. H04L 1/1829

(52) U.S. Cl. CPC H04L 1/1861; H04L 1/1854

(57) ABSTRACT

The present application provides a method and device in a node for wireless communications. A first node receives a second signaling, transmits a second bit set in a second time-frequency resource block. The second signaling indicates the second time-frequency resource block; the second signaling is used to determine a first time-frequency resource block, and the first time-frequency resource block is reserved for a first bit set; whether the second bit set comprises the first bit set is at least related to the second signaling is a first-type signaling or a second-type signaling; when the second signaling is the second-type signaling, the second bit set comprises the first bit set; when the second signaling is the first-type signaling, whether the second bit set comprises the first bit set is related to whether there exists a bit block in the first bit set comprising a HARQ-ACK associated with the second-type signaling.

### CROSS REFERENCE TO RELATED APPLICATIONS

This application claims the priority benefit of Chinese Patent Application No.202111660528.8, filed on December 31,2021, the full disclosure of which is incorporated herein by reference.

### BACKGROUND

### Technical Field

The present application relates to transmission methods and devices in wireless communication systems, and in particular to a method and device of radio signal transmission in wireless communication systems supporting cellular networks.

### Related Art

In traditional Long-Term Evolution (LTE) and Long-Term Evolution Advanced (LTE-A) systems, a base station supports a terminal to receive multicast and groupcast services through Multicast Broadcast Single Frequency Network (MBSFN) and the method of Single-Cell Point-To-Multipoint (SC-PTM). New Radio (NR) Release 17 (R-17) has begun to discuss how to support transmission of multicast and broadcast services under 5G architecture, where two PTM transmission modes are under discussion, one of which is a group-common Physical Downlink Control CHannel (PDCCH) scheduling a group-common Physical Downlink Shared CHannel (PDSCH), and the other is a unicast PDCCH scheduling a unicsat PDSCH. Besides, a Work Item (WI) of URLLC enhancement in NR Release 17 was approved at the 3GPP RAN#86 Plenary, where a Hybrid Automatic Repeat reQuest-ACK (HARQ-ACK) feedback is a focus that needs to be researched.

### SUMMARY

Inventors have found through researches that a relation between HARQ-ACK feedbacks is a key issue to be solved.

To address the above problem, the present application provides a solution. It should be noted that although the uplink and downlink are used as an example in the above description, the application is also applicable to other scenarios, such as sidelink, where similar technical effects can be achieved. Additionally, the adoption of a unified solution for various scenarios (including but not limited to Downlink, Uplink and Sidelink) contributes to the reduction of hardcore complexity and costs. If no conflict is incurred, embodiments in any node in the present application and the characteristics of the embodiments are also applicable to any other node, and vice versa. And the embodiments in the present application and the characteristics in the embodiments can be arbitrarily combined if there is no conflict.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:
receiving a second signaling; and
transmitting a second bit set in a second time-frequency resource block;
herein, the second signaling indicates the second time-frequency resource block; the second signaling is used to determine a first time-frequency resource block, the first time-frequency resource block is reserved for a first bit set, and the first bit set comprises at least one bit block; the second signaling is a first-type signaling or a second-type signaling; whether the second bit set comprises the first bit set is at least related to whether the second signaling is the first-type signaling or the second-type signaling; when the second signaling is the second-type signaling, the second bit set comprises the first bit set; when the second signaling is the first-type signaling, whether the second bit set comprises the first bit set is related to whether there exists a bit block in the first bit set comprising a HARQ-ACK associated with the second-type signaling; the bit block comprises at least one bit.

In one embodiment, a problem to be solved in the present application includes: HARQ-ACK feedback under two types of signaling.

In one embodiment, the above method is essential in that: a first-type signaling and a second-type signaling are two types of signalings, and a second bit set comprises a HARQ-ACK. The advantage of adopting the above method is that HARQ-ACK feedback takes into account types of signalings and effectively supports HARQ-ACK feedback under multiple types of signalings.

According to one aspect of the present application, it is characterized in that when the second signaling is the first-type signaling and there does not exist a bit block in the first bit set comprising a HARQ-ACK associated with the second-type signaling, the second bit set comprises the first bit set; when the second signaling is the first-type signaling and there exists a bit block in the first bit set comprising a HARQ-ACK associated with the second-type signaling, the second bit set does not comprise any bit block in the first bit set.

According to one aspect of the present application, it is characterized in that when the second signaling is the first-type signaling and there does not exist a bit block in the first bit set comprising a HARQ-ACK associated with the second-type signaling, the second bit set comprises the first bit set; when the second signaling is the first-type signaling and there exists a bit block in the first bit set comprising a HARQ-ACK associated with the second-type signaling, the second bit set comprises a bit block in the first bit set only comprising a HARQ-ACK associated with the first-type signaling.

According to one aspect of the present application, comprising:
receiving a third signaling; and receiving a first signaling;
herein, the first signaling indicates the first time-frequency resource block; the first signaling is the second-type signaling, and the third signaling is the first-type signaling; the first bit set comprises multiple bit blocks; two bit blocks in the first bit set respectively comprise a HARQ-ACK associated with the first signaling and a HARQ-ACK associated with a third signaling.

According to one aspect of the present application, it is characterized in that the second signaling indicates a first time offset, the first time offset and a slot to which the second signaling belongs in time domain are used together to determine a first slot, and the first slot is a slot to which the first time-frequency resource block belongs in time domain.

According to one aspect of the present application, it is characterized in that the first-type signaling is scrambled by a first identifier, the second-type is scrambled by a second identifier, and the first identifier is different from the second identifier.

According to one aspect of the present application, it is characterized in that both the first-type signaling and the second-type signaling belong to a first frequency band in frequency domain, only the first-type signaling in the first-type signaling and the second-type signaling is limited in a first frequency-domain resource set in the first frequency band in frequency domain, and the first frequency-domain resource set belongs to the first frequency band.

The present application provides a method in a second node for wireless communications, comprising:
transmitting a second signaling; and
receiving a second bit set in a second time-frequency resource block;
herein, the second signaling indicates the second time-frequency resource block; the second signaling is used to determine a first time-frequency resource block, the first time-frequency resource block is reserved for a first bit set, and the first bit set comprises at least one bit block; the second signaling is a first-type signaling or a second-type signaling; whether the second bit set comprises the first bit set is at least related to whether the second signaling is the first-type signaling or the second-type signaling; when the second signaling is the second-type signaling, the second bit set comprises the first bit set; when the second signaling is the first-type signaling, whether the second bit set comprises the first bit set is related to whether there exists a bit block in the first bit set comprising a HARQ-ACK associated with the second-type signaling; the bit block comprises at least one bit.

According to one aspect of the present application, it is characterized in that when the second signaling is the first-type signaling and there does not exist a bit block in the first bit set comprising a HARQ-ACK associated with the second-type signaling, the second bit set comprises the first bit set; when the second signaling is the first-type signaling and there exists a bit block in the first bit set comprising a HARQ-ACK associated with the second-type signaling, the second bit set does not comprise any bit block in the first bit set.

According to one aspect of the present application, it is characterized in that when the second signaling is the first-type signaling and there does not exist a bit block in the first bit set comprising a HARQ-ACK associated with the second-type signaling, the second bit set comprises the first bit set; when the second signaling is the first-type signaling and there exists a bit block in the first bit set comprising a HARQ-ACK associated with the second-type signaling, the second bit set comprises a bit block in the first bit set only comprising a HARQ-ACK associated with the first-type signaling.

According to one aspect of the present application, comprising:
transmitting a third signaling; and transmitting a first signaling;
herein, the first signaling indicates the first time-frequency resource block; the first signaling is the second-type signaling, and the third signaling is the first-type signaling; the first bit set comprises multiple bit blocks; two bit blocks in the first bit set respectively comprise a HARQ-ACK associated with the first signaling and a HARQ-ACK associated with a third signaling.

According to one aspect of the present application, it is characterized in that the second signaling indicates a first time offset, the first time offset and a slot to which the second signaling belongs in time domain are used together to determine a first slot, and the first slot is a slot to which the first time-frequency resource block belongs in time domain.

According to one aspect of the present application, it is characterized in that the first-type signaling is scrambled by a first identifier, the second-type is scrambled by a second identifier, and the first identifier is different from the second identifier.

According to one aspect of the present application, it is characterized in that both the first-type signaling and the second-type signaling belong to a first frequency band in frequency domain, only the first-type signaling in the first-type signaling and the second-type signaling is limited in a first frequency-domain resource set in the first frequency band in frequency domain, and the first frequency-domain resource set belongs to the first frequency band.

The present application provides a first node for wireless communications, comprising:
a first receiver, receiving a second signaling; and
a first transmitter, transmitting a second bit set in a second time-frequency resource block;
herein, the second signaling indicates the second time-frequency resource block; the second signaling is used to determine a first time-frequency resource block, the first time-frequency resource block is reserved for a first bit set, and the first bit set comprises at least one bit block; the second signaling is a first-type signaling or a second-type signaling; whether the second bit set comprises the first bit set is at least related to whether the second signaling is the first-type signaling or the second-type signaling; when the second signaling is the second-type signaling, the second bit set comprises the first bit set; when the second signaling is the first-type signaling, whether the second bit set comprises the first bit set is related to whether there exists a bit block in the first bit set comprising a HARQ-ACK associated with the second-type signaling; the bit block comprises at least one bit.

The present application provides a second node for wireless communications, comprising:
a second transmitter, transmitting a second signaling; and
a second receiver, receiving a second bit set in a second time-frequency resource block;
herein, the second signaling indicates the second time-frequency resource block; the second signaling is used to determine a first time-frequency resource block, the first time-frequency resource block is reserved for a first bit set, and the first bit set comprises at least one bit block; the second signaling is a first-type signaling or a second-type signaling; whether the second bit set comprises the first bit set is at least related to whether the second signaling is the first-type signaling or the second-type signaling; when the second signaling is the second-type signaling, the second bit set comprises the first bit set; when the second signaling is the first-type signaling, whether the second bit set comprises the first bit set is related to whether there exists a bit block in the first bit set comprising a HARQ-ACK associated with the second-type signaling; the bit block comprises at least one bit.

In one embodiment, the present application has the following advantages over conventional schemes:

HARQ-ACK feedback takes into account types of signalings and effectively supports HARQ-ACK feedback under multiple types of signalings.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of a second signaling and a second bit set according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of wireless communications according to one embodiment of the present application;

FIG. 6 illustrates a schematic diagram of whether the second bit set comprises the first bit set being related to whether there exists a bit block in the first bit set comprising a HARQ-ACK associated with the second-type signaling according to one embodiment of the present application;

FIG. 7 illustrates a schematic diagram of whether the second bit set comprises the first bit set being related to whether there exists a bit block in the first bit set comprising a HARQ-ACK associated with the second-type signaling according to another embodiment of the present application;

FIG. 8 illustrates a schematic diagram of the second signaling being used to determine a first time-frequency resource block according to one embodiment of the present application;

FIG. 9 illustrates a schematic diagram of a first-type signaling and a second-type signaling according to one embodiment of the present application;

FIG. 10 illustrates a schematic diagram of a first-type signaling and a second-type signaling according to another embodiment of the present application;

FIG. 11 illustrates a structure block diagram of a processing device in a first node according to one embodiment of the present application;

FIG. 12 illustrates a structure block diagram of a processing device in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

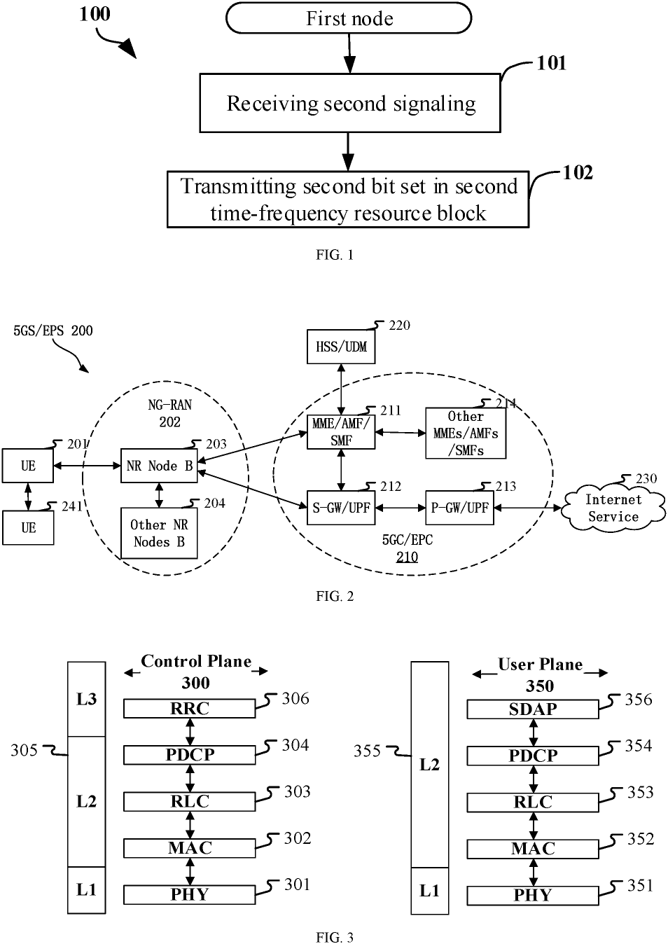

Embodiment 1 illustrates a flowchart of a second signaling and a second bit set according to one embodiment of the present application, as shown in FIG. 1. In step 100 illustrated by FIG. 1, each box represents a step.

In Embodiment 1, the first node in the present application receives a second signaling in step 101; transmits a second information block in a second time-frequency resource block in step 102; herein, the second signaling indicates the second time-frequency resource block; the second signaling is used to determine a first time-frequency resource block, the first time-frequency resource block is reserved for a first bit set, and the first bit set comprises at least one bit block; the second signaling is a first-type signaling or a second-type signaling; whether the second bit set comprises the first bit set is at least related to whether the second signaling is the first-type signaling or the second-type signaling; when the second signaling is the second-type signaling, the second bit set comprises the first bit set; when the second signaling is the first-type signaling, whether the second bit set comprises the first bit set is related to whether there exists a bit block in the first bit set comprising a HARQ-ACK associated with the second-type signaling; the bit block comprises at least one bit.

In one embodiment, the second signaling is a physical-layer signaling.

In one embodiment, the second signaling is a Downlink Control Information (DCI) signaling.

In one embodiment, the second signaling triggers a re-transmission of the first bit set.

In one embodiment, the second signaling triggers a HARQ re-transmission.

In one embodiment, the second signaling does not schedule a PDSCH, and the second signaling triggers a HARQ re-transmission.

In one embodiment, the first field triggers a HARQ-ACK re-transmission.

In one embodiment, the second signaling comprises a first field, a value of the first field in the second signaling is 1, and the first field only comprises one bit; a value of the first field being set to 0 indicates not triggering a HARQ re-transmission, and a value of the first field being set to 1 indicates triggering a HARQ re-transmission.

In one embodiment, the first time-frequency resource block comprises PUCCH resources, and the second time-frequency resource block comprises PUCCH resources; the first time-frequency resource block is reserved for a transmission of the first bit set; when the second bit set comprises at least one bit block in the first bit set, the second time-frequency resource block is used for a retransmission of the at least one bit block in the first bit set.

In one embodiment, the first time-frequency resource block comprises PUCCH resources, and the second time-frequency resource block comprises PUCCH resources; the first time-frequency resource block is reserved for a transmission of the first bit set; the second bit set comprises a third bit subset, or, the second bit set comprises at least one bit block in a third bit subset and the first bit set; the third bit subset comprises at least one bit block; when the second bit set comprises at least one bit block in the first bit set, the second time-frequency resource block is used for a retransmission of the at least one bit block in the first bit set and a transmission of the third bit subset.

In one embodiment, the second time-frequency resource block is later than time-domain resources occupied by the second signaling in time domain.

In one embodiment, the second time-frequency resource block comprises at least one symbol in time domain.

In one embodiment, the second time-frequency resource block comprises at least one subcarrier in frequency domain.

In one embodiment, the second time-frequency resource block comprises at least one Resource Block (RB) in frequency domain.

In one embodiment, the second time-frequency resource block comprises at least one Resource Element (RE).

In one embodiment, the second time-frequency resource block comprises Physical Uplink Control CHannel (PUCCH) resources.

In one embodiment, the second time-frequency resource block comprises Physical Uplink Shared CHannel (PUSCH) resources.

In one embodiment, an RE occupies a symbol in time domain and occupies a subcarrier in frequency domain.

In one embodiment, the second signaling is used to indicate the second time-frequency resource block from a target resource set, and the target resource set comprises multiple time-frequency resource blocks.

In one embodiment, the second signaling indicates an index of the second time-frequency resource block in a target resource set, and the target resource set comprises multiple time-frequency resource blocks.

In one embodiment, the second signaling comprises a second field, the second signaling is used to indicate the second time-frequency resource block from a target resource set, and the target resource set comprises multiple time-frequency resource blocks; the second field comprises at least one bit.

In one embodiment, the second signaling comprises a second field, the second signaling indicates an index of the second time-frequency resource block in a target resource set, and the target resource set comprises multiple time-frequency resource blocks; the second field comprises at least one bit.

In one embodiment, the second field comprises 3 bits.

In one embodiment, the second field is a PUCCH resource indicator field.

In one embodiment, for the specific meaning of the PUCCH resource indicator field, refer to section 7.3.1 in 3GPP TS38.212.

In one embodiment, one time-frequency resource block comprises at least one symbol in time domain.

In one embodiment, one time-frequency resource block comprises at least one subcarrier in frequency domain.

In one embodiment, one time-frequency resource block comprises at least one RB in frequency domain.

In one embodiment, one time-frequency resource block comprises at least one Resource Element (RE).

In one embodiment, time-domain resources occupied by the second signaling are earlier than time-domain resources occupied by the first time-frequency resource block.

In one embodiment, time-domain resources occupied by the second signaling are not later than time-domain resources occupied by the first time-frequency resource block.

In one embodiment, time-domain resources occupied by the second signaling are later than time-domain resources occupied by the first time-frequency resource block.

In one embodiment, the second time-frequency resource block is later than the first time-frequency resource block in time domain.

In one embodiment, the second time-frequency resource block is not earlier than the first time-frequency resource block in time domain.

In one embodiment, the meaning of the phrase of “the second signaling being used to determine a first time-frequency resource block” comprises: the second signaling is used to determine the first bit set, and the first time-frequency resource block comprises time-frequency resources reserved for the first bit set.

In one embodiment, the meaning of the phrase of “the second signaling being used to determine the first bit set” comprises: the second signaling triggers the first bit set.

In one embodiment, the meaning of the phrase of “the second signaling being used to determine the first bit set” comprises: the second signaling triggers the first bit set, and a number of bit block(s) comprised in the first bit set is configured by higher layer parameters.

In one embodiment, the meaning of the phrase of “the second signaling being used to determine the first bit set” comprises: the second signaling indicates a number of bit block(s) comprised in the first bit set.

In one embodiment, the meaning of the phrase of “the second signaling being used to determine a first time-frequency resource block” comprises: the second signaling is used to indicate a first time-frequency resource block.

In one embodiment, the meaning of the phrase of “the second signaling being used to determine a first time-frequency resource block” comprises: the second signaling indicates a first time offset, and the first time offset and time-domain resources occupied by the second signaling are used together to determine a first time-frequency resource block.

In one embodiment, the meaning of the phrase of “the first time offset and time-domain resources occupied by the second signaling being used together to determine a first time-frequency resource block” refers to: time-domain resources occupied by the second signaling are used to determine a first time, a second time is equal to the first time subtracting the first time offset, and the first time-frequency resource block is not later than the second time.

In one embodiment, the meaning of the phrase of “the first time offset and time-domain resources occupied by the second signaling being used together to determine a first time-frequency resource block” refers to: time-domain resources occupied by the second signaling are used to determine a first time, a second time is equal to the first time subtracting the first time offset, the second time is used to determine a reference slot, the first time-frequency resource block belongs to the reference slot, and the reference slot is a slot.

In one embodiment, the meaning of the phrase of “the second time being used to determine a reference slot” refers to: the first time offset is a non-negative real number, the second time is not later than the first time, and the reference slot is a latest slot not later than the second time.

In one embodiment, the meaning of the phrase of “the second time being used to determine a reference slot” refers to: the first time offset is a negative real number, the second time is later than the first time, and the reference slot is an earliest slot not earlier than the second time.

In one embodiment, the meaning of the phrase of “the second time being used to determine a reference slot” refers to: the reference slot is a slot to which the second time belongs.

In one embodiment, the meaning of the phrase of “the second time being used to determine a reference slot” refers to: the reference slot is a slot closet to the second time.

In one embodiment, the meaning of “a slot being earlier than a time” refers to: an end time of a slot is earlier than a time.

In one embodiment, the meaning of “a slot being earlier than a time” refers to: a start time of a slot is earlier than a time.

In one embodiment, the meaning of “a slot being not earlier than a time” refers to: an end time of a slot is not earlier than a time.

In one embodiment, the meaning of “a slot being not earlier than a time” refers to: a start time of a slot is not earlier than a time.

In one embodiment, the meaning of “a slot being later than a time” refers to: an end time of a slot is later than a time.

In one embodiment, the meaning of “a slot being later than a time” refers to: a start time of a slot is later than a time.

In one embodiment, the meaning of “a slot being not later than a time” refers to: an end time of a slot is not later than a time.

In one embodiment, the meaning of “a slot being not later than a time” refers to: a start time of a slot is not later than a time.

In one embodiment, the meaning of the phrase of “the first time-frequency resource block being not later than the second time” refers to: an end time of the first time-frequency resource block is not later than the second time.

In one embodiment, the meaning of the phrase of “the first time-frequency resource block being not later than the second time” refers to: a start time of the first time-frequency resource block is not later than the second time.

In one embodiment, the meaning of the phrase of “the first time-frequency resource block being reserved for a first bit set” comprises: the first time-frequency resource block is indicated to a first bit set.

In one embodiment, the meaning of the phrase of “the first time-frequency resource block being reserved for a first bit set” comprises: the first time-frequency resource block is indicated to a transmission of a first bit set.

In one embodiment, the meaning of the phrase of “the first time-frequency resource block being reserved for a first bit set” comprises: the first time-frequency resource block is reserved for a transmission of a first bit set.

In one embodiment, the meaning of the phrase of “the first time-frequency resource block being reserved for a first bit set” comprises: a first bit set is transmitted in the first time-frequency resource block.

In one embodiment, the meaning of the phrase of “the first time-frequency resource block being reserved for a first bit set” comprises: a first bit set is transmitted in the first time-frequency resource block, or, a first bit set is not transmitted in the first time-frequency resource block.

In one embodiment, the meaning of the phrase of “the first time-frequency resource block being reserved for a first bit set” comprises: a first bit set is actually not transmitted in a first time-frequency resource block.

In one embodiment, the first bit set comprises at least one of at least one bit block comprising a HARQ-ACK associated with the first-type signaling, or at least one bit block comprising a HARQ-ACK associated with the second-type signaling.

In one embodiment, the first bit set comprises a HARQ-ACK.

In one embodiment, any bit block in the first bit set comprises a HARQ-ACK.

In one embodiment, any bit block in the first bit set comprises a HARQ-ACK associated with the first-type signaling or a HARQ-ACK associated with the second-type signaling.

In one embodiment, any bit block in the first bit set comprises a HARQ-ACK associated with the first-type signaling.

In one embodiment, any bit block in the first bit set comprises a HARQ-ACK associated with the second-type signaling.

In one embodiment, there exists a bit block in the first bit set comprising a HARQ-ACK associated with the first-type signaling, and there exists a bit block in the first bit set comprising a HARQ-ACK associated with the second-type signaling.

In one embodiment, the first bit set only comprises a bit block.

In one embodiment, the first bit set comprises multiple bit blocks.

In one embodiment, the phrase of “a HARQ-ACK associated with a given signaling” indicates whether the given signaling is correctly received.

In one embodiment, the phrase of “a HARQ-ACK associated with a given signaling” indicates a HARQ-ACK for the given signaling.

In one embodiment, a given signaling schedules a signal, and the phrase of “a HARQ-ACK associated with a given signaling” indicates whether a signal scheduled by the given signaling is correctly received.

In one embodiment, a given signaling schedules a signal, and the phrase of “a HARQ-ACK associated with a given signaling” indicates a HARQ-ACK for a signal scheduled by the given signaling.

In one embodiment, a given signaling does not schedule a signal, and the phrase of “a HARQ-ACK associated with a given signaling” indicates a HARQ-ACK for the given signaling.

In one embodiment, the signal scheduled by the given signaling is a PDSCH.

In one embodiment, the signal scheduled by the given signaling is a downlink signal.

In one embodiment, the given signaling is the second signaling.

In one embodiment, the given signaling is the first signaling.

In one embodiment, the given signaling is the third signaling.

In one embodiment, the given signaling is the fourth signaling.

In one embodiment, the given signaling is the first-type signaling.

In one embodiment, the given signaling is the second-type signaling.

In one embodiment, the second bit set comprises a HARQ-ACK associated with the second signaling.

In one embodiment, the second bit set at least comprises a HARQ-ACK associated with the second signaling.

In one embodiment, the second bit set comprises at least one bit block, and one bit block in the second bit set comprises a HARQ-ACK associated with the second signaling.

In one embodiment, the first receiver receives a fourth signaling; herein, the second bit set comprises a HARQ-ACK associated with the fourth signaling.

In one embodiment, the fourth signaling indicates a target slot, and the target slot is the same as a slot to which the second time-frequency resource block belongs.

In one embodiment, any bit block in the second bit set does not indicate whether the second signaling is correctly received.

In one embodiment, the second signaling does not schedule a signal, and any bit block in the second bit set does not indicate whether the second signaling is correctly received.

In one embodiment, the second signaling does not schedule a signal, and any bit block in the second bit set does not indicate a HARQ-ACK for the second signaling.

In one embodiment, the second signaling does not schedule a PDSCH, and any bit block in the second bit set does not indicate whether the second signaling is correctly received.

In one embodiment, the second signaling does not schedule a PDSCH, and any bit block in the second bit set does not indicate a HARQ-ACK for the second signaling.

In one embodiment, the second bit set at least comprises a HARQ-ACK associated with the fourth signaling.

In one embodiment, the second bit set comprises at least one bit block, and one bit block in the second bit set comprises a HARQ-ACK associated with the fourth signaling.

In one embodiment, the second bit set comprises a third bit subset, or, the second bit set comprises at least one bit block in a third bit subset and the first bit set; the third bit subset comprises at least one bit block.

In one embodiment, when the second bit set comprises at least one bit block in a third bit subset and the first bit set, at least one bit in the first bit set is appended to the third bit subset.

In one embodiment, the third bit subset comprises a HARQ-ACK associated with the second signaling.

In one embodiment, the third bit subset comprises a HARQ-ACK associated with the fourth signaling.

In one embodiment, one bit block in the third bit subset comprises a HARQ-ACK associated with the second signaling.

In one embodiment, one bit block in the third bit subset comprises a HARQ-ACK associated with the fourth signaling.

In one embodiment, the second signaling indicates a number of bit block(s) comprised in the third bit subset.

In one embodiment, one field in the second signaling indicates a number of bit block(s) comprised in the third bit subset.

In one embodiment, a Downlink assignment index field in the second signaling indicates a number of bit block(s) comprised in the third bit subset.

In one embodiment, for the specific meaning of the Downlink assignment index field, refer to section 7.3.1 in 3GPP TS38.212.

In one embodiment, the second-type signaling is unicast, and the first-type signaling is non-unicast.

In one embodiment, the second-type signaling is transmitted on a unicast channel, and the first-type signaling is transmitted on a non-unicast channel.

In one embodiment, both the first-type signaling and the second-type signaling are physical-layer signalings.

In one embodiment, the first-type signaling and the second-type signaling are two types of physical-layer signalings.

In one embodiment, both the first-type signaling and the second-type signaling are transmitted on a PDCCH.

In one embodiment, the first-type signaling and the second-type signaling are DCI signalings scrambled by different Radio network temporary identifiers (RNTIs).

In one embodiment, the second-type signaling is used to schedule unicast services, and the first-type signaling is used to schedule non-unicast services.

In one embodiment, the second-type is UE-specific, and the first-type signaling is UE group-common.

In one embodiment, the second-type is UE-specific, and the first-type signaling is cell-common.

In one embodiment, the unicast services comprise Point-To-Point (PTP) services.

In one embodiment, the unicast services comprise unicast services.

In one embodiment, the non-unicast services comprise Point-To-Multipoint (PTM) services.

In one embodiment, the non-unicast services comprise multicast services.

In one embodiment, the non-unicast services comprise Multicast Broadcast Services.

In one embodiment, the non-unicast channel comprises a Multicast Broadcast Service channel.

In one embodiment, the non-unicast channel comprises a Multicast Broadcast channel.

In one embodiment, the non-unicast channel comprises a multicast channel.

### Embodiment 2

Embodiment 2 illustrates a schematic diagram of a network architecture according to one embodiment of the present application, as shown in FIG. 2.

FIG. 2 is a diagram illustrating a network architecture 200 of Long-Term Evolution (LTE), Long-Term Evolution Advanced (LTE-A) and future 5G systems. The LTE, LTE-A and future 5G systems network architecture 200 may be called an Evolved Packet System (EPS) 200. The 5G NR or LTE network architecture 200 may be called a 5G System (5GS)/Evolved Packet System (EPS) 200 or other appropriate terms. The 5GS/ EPS 200 may comprise one or more UEs 201, a UE 241 that is in Sidelink communications with a UE 201, an NG-RAN 202, a 5G-Core Network/Evolved Packet Core (5GC/ EPC) 210, a Home Subscriber Server (HSS)/ Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), Satellite Radios, Global Positioning Systems (GPSs), multimedia devices, video devices, digital audio players (for example, MP3 players), cameras, game consoles, unmanned aerial vehicles (UAV), aircrafts, narrow-band physical network devices, machine-type communication devices, land vehicles, automobiles, wearable devices, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/ Authentication Management Field (AMF)/ Session Management Function (SMF) 211, other MMEs/ AMFs/ SMFs 214, a Service Gateway (S-GW)/ User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Services.

In one embodiment, the first node in the present application comprises the UE 201.

In one embodiment, the second node in the present application comprises the gNB 203.

### Embodiment 3

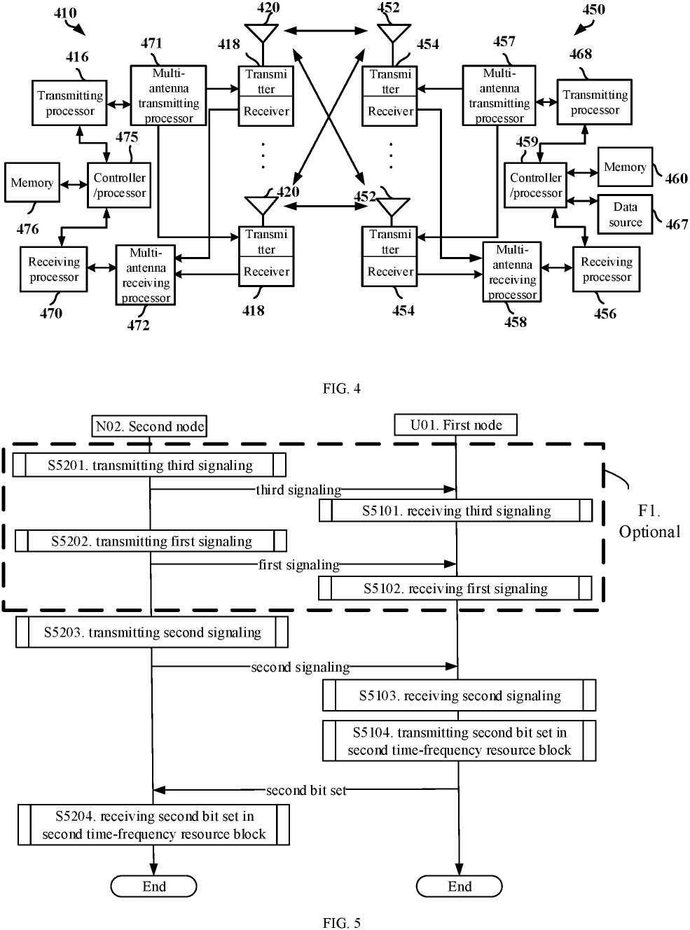

Embodiment 3 illustrates a schematic diagram of a radio protocol architecture of a user plane and a control plane according to one embodiment of the present application, as shown in FIG. 3.

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB, UE or an RSU in V2X), or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first communication node and a second communication node, or between two UEs. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of services. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first information block set is generated by the RRC sublayer 306.

In one embodiment, the second signaling is generated by the PHY 301 or the PHY 351.

In one embodiment, the second bit set is generated by the PHY 301 or the PHY 351.

In one embodiment, the third signaling is generated by the PHY 301 or the PHY 351.

In one embodiment, the first signaling is generated by the PHY 301 or the PHY 351.

### Embodiment 4

Embodiment 4 illustrates a schematic diagram of a first communication device and a second communication device according to one embodiment of the present application, as shown in FIG. 4. FIG. 4 is a block diagram of a first communication device 410 in communication with a second communication device 450 in an access network.

The first communication device 410 comprises a controller/ processor 475, a memory 476, a receiving processor 470, a transmitting processor 416, a multi-antenna receiving processor 472, a multi-antenna transmitting processor 471, a transmitter/ receiver 418 and an antenna 420.

The second communication device 450 comprises a controller/ processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from the core network is provided to a controller/ processor 475. The controller/processor 475 provides a function of the L2 layer. In DL transmission, the controller/processor 475 provides header compression, encryption, packet segmentation and reordering, and multiplexing between a logical channel and a transport channel, and radio resource allocation for the second communication device 450 based on various priorities. The controller/processor 475 is also in charge of HARQ operation, retransmission of a lost packet, and a signaling to the second communication node 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 450, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more parallel streams. The transmitting processor 416 then maps each parallel stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any second communication device 450-targeted parallel stream. Symbols on each parallel stream are demodulated and recovered in the receiving processor 456 to generate a soft decision. Then the receiving processor 456 decodes and de-interleaves the soft decision to recover the higher-layer data and control signal transmitted on the physical channel by the first communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In downlink(DL) transmission, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing. The controller/processor 459 also performs error detection using ACK and/or NACK protocols as a way to support HARQ operation.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in DL transmission, the controller/processor 459 performs header compression, encryption, packet segmentation and reordering, and multiplexing between a logical channel and a transport channel based on radio resource allocation of the first communication device 410 so as to provide the L2 layer functions used for the user plane and the control plane. The controller/processor 459 is also responsible for HARQ operation, retransmission of a lost packet, and a signaling to the first communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated parallel streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. the controller/processor 475 provides de-multiplexing between a transport channel and a logical channel, packet reassembling, decryption, header decompression, control signal processing so as to recover a higher-layer packet from the second communication device 450. The higher-layer packet coming from the controller/processor 475 may be provided to the core network. The controller/processor 475 can also perform error detection using ACK and/or NACK protocols to support HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least: receives a second signaling; and transmits a second bit set in a second time-frequency resource block; herein, the second signaling indicates the second time-frequency resource block; the second signaling is used to determine a first time-frequency resource block, the first time-frequency resource block is reserved for a first bit set, and the first bit set comprises at least one bit block; the second signaling is a first-type signaling or a second-type signaling; whether the second bit set comprises the first bit set is at least related to whether the second signaling is the first-type signaling or the second-type signaling; when the second signaling is the second-type signaling, the second bit set comprises the first bit set; when the second signaling is the first-type signaling, whether the second bit set comprises the first bit set is related to whether there exists a bit block in the first bit set comprising a HARQ-ACK associated with the second-type signaling; the bit block comprises at least one bit.

In one embodiment, the second communication device 450 comprises a memory that stores a computer readable instruction program. The computer readable instruction program generates an action when executed by at least one processor. The action includes: receiving a second signaling; and transmitting a second bit set in a second time-frequency resource block; herein, the second signaling indicates the second time-frequency resource block; the second signaling is used to determine a first time-frequency resource block, the first time-frequency resource block is reserved for a first bit set, and the first bit set comprises at least one bit block; the second signaling is a first-type signaling or a second-type signaling; whether the second bit set comprises the first bit set is at least related to whether the second signaling is the first-type signaling or the second-type signaling; when the second signaling is the second-type signaling, the second bit set comprises the first bit set; when the second signaling is the first-type signaling, whether the second bit set comprises the first bit set is related to whether there exists a bit block in the first bit set comprising a HARQ-ACK associated with the second-type signaling; the bit block comprises at least one bit.

In one embodiment, the first communication device 410 comprises at least one processor and at least one memory. The at least one memory comprises computer program codes; the at least one memory and the computer program codes are configured to be used in collaboration with the at least one processor. The first communication device 410 at least: transmits a second signaling; and receives a second bit set in a second time-frequency resource block; herein, the second signaling indicates the second time-frequency resource block; the second signaling is used to determine a first time-frequency resource block, the first time-frequency resource block is reserved for a first bit set, and the first bit set comprises at least one bit block; the second signaling is a first-type signaling or a second-type signaling; whether the second bit set comprises the first bit set is at least related to whether the second signaling is the first-type signaling or the second-type signaling; when the second signaling is the second-type signaling, the second bit set comprises the first bit set; when the second signaling is the first-type signaling, whether the second bit set comprises the first bit set is related to whether there exists a bit block in the first bit set comprising a HARQ-ACK associated with the second-type signaling; the bit block comprises at least one bit.

In one embodiment, the first communication device 410 comprises a memory that stores a computer readable instruction program. The computer readable instruction program generates an action when executed by at least one processor. The action includes: transmitting a second signaling; and receiving a second bit set in a second time-frequency resource block; herein, the second signaling indicates the second time-frequency resource block; the second signaling is used to determine a first time-frequency resource block, the first time-frequency resource block is reserved for a first bit set, and the first bit set comprises at least one bit block; the second signaling is a first-type signaling or a second-type signaling; whether the second bit set comprises the first bit set is at least related to whether the second signaling is the first-type signaling or the second-type signaling; when the second signaling is the second-type signaling, the second bit set comprises the first bit set; when the second signaling is the first-type signaling, whether the second bit set comprises the first bit set is related to whether there exists a bit block in the first bit set comprising a HARQ-ACK associated with the second-type signaling; the bit block comprises at least one bit.

In one embodiment, the first node comprises the second communication device 450 in the present application.

In one embodiment, the second node in the present application comprises the first communication device 410.

In one embodiment, at least one of the antenna 452, the receiver 454, the receiving processor 456, the multi-antenna receiving processor 458, the controller/processor 459, the memory 460, or the data source 467 is used to receive the first signaling in the present application; at least one of the antenna 420, the transmitter 418, the transmitting processor 416, the multi-antenna transmitting processor 471, the controller/processor 475, or the memory 476 is used to transmit the first signaling in the present application.

In one embodiment, at least one of the antenna 452, the receiver 454, the receiving processor 456, the multi-antenna receiving processor 458, the controller/processor 459, the memory 460, or the data source 467 is used to receive the second signaling in the present application; at least one of the antenna 420, the transmitter 418, the transmitting processor 416, the multi-antenna transmitting processor 471, the controller/processor 475, or the memory 476 is used to transmit the second signaling in the present application.

In one embodiment, at least one of the antenna 452, the receiver 454, the receiving processor 456, the multi-antenna receiving processor 458, the controller/processor 459, the memory 460, or the data source 467 is used to receive a third signaling of the present application; at least one of the antenna 420, the transmitter 418, the transmitting processor 416, the multi-antenna transmitting processor 471, the controller/processor 475, or the memory 476 is used to transmit the third signaling of the present application.

In one embodiment, at least one of the antenna 452, the receiver 454, the receiving processor 456, the multi-antenna receiving processor 458, the controller/processor 459, the memory 460, or the data source 467 is used to receive the first-type signaling and the second-type signaling in the present application; at least one of the antenna 420, the transmitter 418, the transmitting processor 416, the multi-antenna transmitting processor 471, the controller/processor 475, or the memory 476 is used to transmit the first-type signaling and the second-type signaling in the present application.

In one embodiment, at least one of the antenna 452, the transmitter 454, the transmitting processor 468, the multi-antenna transmitting processor 457, the controller/processor 459, or the memory 460 is used to transmit the second bit set in the present application in the second time-frequency resource block in the present application; at least one of the antenna 420, the receiver 418, the receiving processor 470, the multi-antenna receiving processor 472, the controller/ processor 475, or the memory 476 is used to receive the second bit set in the present application in the second time-frequency resource block in the present application.

### Embodiment 5

Embodiment 5 illustrates a flowchart of wireless communications according to one embodiment in the present application, as shown in FIG. 5. In FIG. 5, a first node U01 and a second node N02 are respectively communication nodes transmitted via an air interface; in FIG. 5, steps in box F1 are optional.

The first node U01 receives a third signaling in step S5101; and receives a first signaling in step S5102; receives a second signaling in step S5103; transmits a second information block in a second time-frequency resource block in step S5104;

The second node N02 transmits a third signaling in step S5201; transmits a first signaling in step S5202; transmits a second signaling in step S5203; and receives a second bit set in a second time-frequency resource block in step S524.

In embodiment 5, the second signaling indicates the second time-frequency resource block; the second signaling is used to determine a first time-frequency resource block, the first time-frequency resource block is reserved for a first bit set, and the first bit set comprises at least one bit block; the second signaling is a first-type signaling or a second-type signaling; whether the second bit set comprises the first bit set is at least related to whether the second signaling is the first-type signaling or the second-type signaling; when the second signaling is the second-type signaling, the second bit set comprises the first bit set; when the second signaling is the first-type signaling, whether the second bit set comprises the first bit set is related to whether there exists a bit block in the first bit set comprising a HARQ-ACK associated with the second-type signaling; the bit block comprises at least one bit.

In one embodiment, the first signaling indicates the first time-frequency resource block; the first signaling is the second-type signaling, and the third signaling is the first-type signaling; the first bit set comprises multiple bit blocks; two bit blocks in the first bit set respectively comprise a HARQ-ACK associated with the first signaling and a HARQ-ACK associated with a third signaling.

In one embodiment, the first signaling is later than the third signaling in time domain.

In one embodiment, the first signaling is not later than the third signaling in time domain.

In one embodiment, the first signaling is earlier than the third signaling in time domain.

In one embodiment, the first signaling is earlier than the second signaling in time domain.

In one embodiment, the first signaling is a physical-layer signaling.

In one embodiment, the first signaling is a Downlink Control Information (DCI) signaling.

In one embodiment, the first signaling is used to indicate the first time-frequency resource block from a target resource set, and the target resource set comprises multiple time-frequency resource blocks.

In one embodiment, the first signaling indicates an index of the first time-frequency resource block in a target resource set, and the target resource set comprises multiple time-frequency resource blocks.

In one embodiment, the first signaling comprises a second field, the second field in the first signaling is used to indicate the first time-frequency resource block from a target resource set, and the target resource set comprises multiple time-frequency resource blocks; the second field comprises at least one bit.

In one embodiment, the first signaling comprises a second field, the second field in the first signaling indicates an index of the first target time-frequency resource block in a target resource set, and the target resource set comprises multiple time-frequency resource blocks; the second field comprises at least one bit.

In one embodiment, the first receiver receives a first signal; herein, the first signaling schedules the first signal.

In one embodiment, the first node receives a first signal; herein, the first signaling schedules the first signal.

In one embodiment, the second transmitter transmits a first signal; herein, the first signaling schedules the first signal.

In one embodiment, the second node transmits a first signal; herein, the first signaling schedules the first signal.

In one embodiment, the third signaling is earlier than the second signaling in time domain.

In one embodiment, the third signaling is a physical-layer signaling.

In one embodiment, the third signaling is a Downlink Control Information (DCI) signaling.

In one embodiment, the first receiver receives a second signal; herein, the third signaling schedules the second signal.

In one embodiment, the first node receives a second signal; herein, the third signaling schedules the second signal.

In one embodiment, the second transmitter transmits a second signal; herein, the third signaling schedules the second signal.

In one embodiment, the second node transmits a second signal; herein, the third signaling schedules the second signal.

In one embodiment, the first bit set comprises a first bit subset and a second bit subset, any bit block in the first bit subset comprises a HARQ-ACK associated with the first-type signaling, and any bit block in the second subset comprises a HARQ-ACK associated with the second-type signaling; a bit block in the first bit subset comprises a HARQ-ACK associated with the third signaling, and a bit block in the second bit subset comprises a HARQ-ACK associated with the first signaling.

In one embodiment, the first signaling indicates a number of bit block(s) comprised in the first bit set.

In one embodiment, the first signaling indicates a number of bit block(s) comprised in the second bit subset, and the third signaling indicates a number of bit block(s) comprised in the first bit subset.

In one embodiment, one field in the first signaling indicates a number of bit block(s) comprised in the first bit set.

In one embodiment, one field in the first signaling indicates a number of bit block(s) comprised in the second bit subset, and one field in the third signaling indicates a number of bit block(s) comprised in the first bit subset.

In one embodiment, a Downlink assignment index field in the first signaling indicates a number of bit block(s) comprised in the first bit set.

In one embodiment, a Downlink assignment index in the first signaling indicates a number of bit block(s) comprised in the second bit subset, and a Downlink assignment index field in the third signaling indicates a number of bit block(s) comprised in the first bit subset.

### Embodiment 6

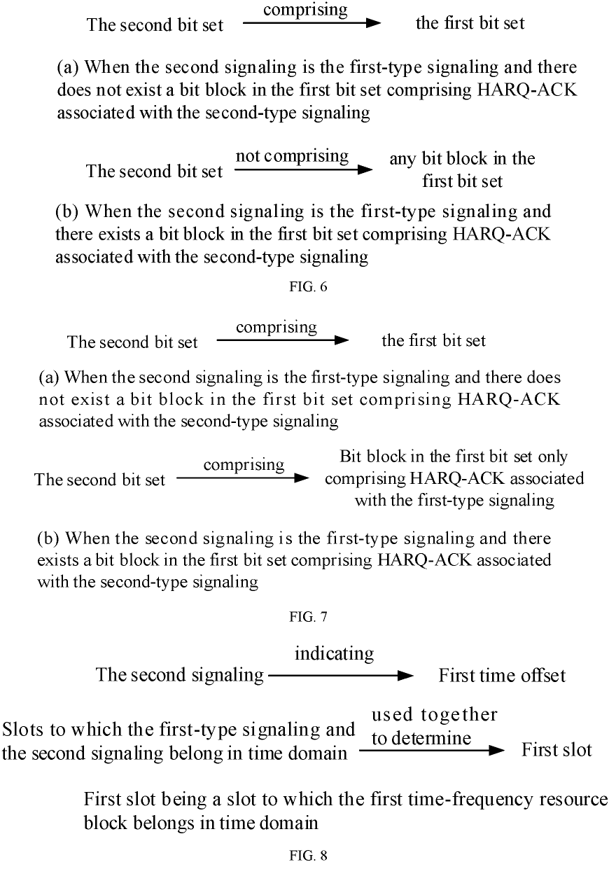

Embodiment 6 illustrates a schematic diagram of whether the second bit set comprises the first bit set being related to whether there exists a bit block in the first bit set comprising a HARQ-ACK associated with the second-type signaling according to one embodiment of the present application, as shown in FIG. 6.

In embodiment 6, when the second signaling is the first-type signaling and there does not exist a bit block in the first bit set comprising a HARQ-ACK associated with the second-type signaling, the second bit set comprises the first bit set; when the second signaling is the first-type signaling and there exists a bit block in the first bit set comprising a HARQ-ACK associated with the second-type signaling, the second bit set does not comprise any bit block in the first bit set.

In one embodiment, whether the second bit set comprises at least one bit block in the first bit set is related to whether there exists a bit block in the first bit set comprising a HARQ-ACK associated with the second-type signaling.

### Embodiment 7

Embodiment 6 illustrates a schematic diagram of whether the second bit set comprises the first bit set being related to whether there exists a bit block in the first bit set comprising a HARQ-ACK associated with the second-type signaling according to another embodiment of the present application, as shown in FIG. 7.

In embodiment 7, when the second signaling is the first-type signaling and there does not exist a bit block in the first bit set comprising a HARQ-ACK associated with the second-type signaling, the second bit set comprises the first bit set; when the second signaling is the first-type signaling and there exists a bit block in the first bit set comprising a HARQ-ACK associated with the second-type signaling, the second bit set comprises a bit block in the first bit set only comprising a HARQ-ACK associated with the first-type signaling.

In one embodiment, when the second signaling is the first-type signaling and there exists a bit block in the first bit set comprising a HARQ-ACK associated with the second-type signaling, the second bit set does not comprise the first bit set.

In one embodiment, the meaning of the phrase of “the second bit set not comprising the first bit set” comprises: there exists a bit block in the first bit set not belonging to the second bit set.

In one embodiment, the meaning of the phrase of “the second bit set not comprising the first bit set” comprises: there exists a bit block in the first bit set not belonging to the second bit set, and there exists a bit bock in the first bit set belonging to the second bit set.

In one embodiment, the meaning of the phrase of “the second bit set not comprising the first bit set” comprises: any bit block in the first bit set does not belong to the second bit set.

In one embodiment, the meaning of the phrase of “the second bit set not comprising the first bit set” comprises: there exists one bit block in the first bit set not belonging to the second bit set.

In one embodiment, the meaning of the phrase of “the second bit set not comprising the first bit set” comprises: the second bit set comprises a bit block in the first bit set only comprising a HARQ-ACK associated with the first-type signaling, and there exists a bit block in the first bit set comprising a HARQ-ACK associated with the second-type signaling not belonging to the second bit set.

In one embodiment, the meaning of the phrase of “the second bit set not comprising the first bit set” comprises: the second bit set comprises a bit block in the first bit set only comprising a HARQ-ACK associated with the first-type signaling, and any bit block in the first bit set comprising a HARQ-ACK associated with the second-type signaling does not belong to the second bit set.

### Embodiment 8

Embodiment 8 illustrates a schematic diagram of the second signaling being used to determine a first time-frequency resource block according to one embodiment of the present application, as shown in FIG. 8.

In embodiment 8, the second signaling indicates a first time offset, the first time offset and a slot to which the second signaling belongs in time domain are used together to determine a first slot, and the first slot is a slot to which the first time-frequency resource block belongs in time domain.

In one embodiment, a field in the second signaling indicates a first time offset.

In one embodiment, at least one field in the second signaling indicates a first time offset.

In one embodiment, the first time offset is a real number.

In one embodiment, the first time offset is an integer.

In one embodiment, the first time offset is a non-negative real number.

In one embodiment, the first time offset is a positive real number.

In one embodiment, the first time offset is a non-negative integer.

In one embodiment, the first time offset is a positive integer.

In one embodiment, the first time offset is measured by millisecond.

In one embodiment, the first time offset is measured by slot.

In one embodiment, the meaning of the phrase of “the first time offset and a slot to which the second signaling belongs in time domain being used together to determine a first slot” comprises: the first time offset is an offset between a slot to which the second signaling belongs in time domain and the first slot.

In one embodiment, the meaning of the phrase of “the first time offset and a slot to which the second signaling belongs in time domain being used together to determine a first slot” comprises: the first time offset is measured by slot, and the first time offset is an offset between a slot to which the second signaling belongs in time domain and the first slot.

In one embodiment, the meaning of the phrase of “the first time offset and a slot to which the second signaling belongs in time domain being used together to determine a first slot” comprises: the first time offset is not less than 0, the first slot is not later than the slot to which the second signaling belongs in time domain, and the first offset is an offset between a slot to which the second signaling belongs in time domain and the first slot.

In one embodiment, the meaning of the phrase of “the first time offset and a slot to which the second signaling belongs in time domain being used together to determine a first slot” comprises: the first time offset is less than 0, the first slot is later than the slot to which the second signaling belongs in time domain, and the first offset is an offset between a slot to which the second signaling belongs in time domain and the first slot.

In one embodiment, the meaning of the phrase of “the first time offset and a slot to which the second signaling belongs in time domain being used together to determine a first slot” comprises: the first time offset is measured by slot, and the first time offset is equal to an index of the slot to which the second signaling belongs in time domain subtracting an index of the first slot.

In one embodiment, the offset between a slot to which the second signaling belongs in time domain and the first slot is equal to an index of the slot to which the second signaling belongs in time domain subtracting an index of the first slot.

In one embodiment, the offset between a slot to which the second signaling belongs in time domain and the first slot is equal to a start time of the slot to which the second signaling belongs in time domain subtracting a start time of the first slot.

In one embodiment, the offset between a slot to which the second signaling belongs in time domain and the first slot is equal to an end time of the slot to which the second signaling belongs in time domain subtract an end time of the first slot.

In one embodiment, one slot comprises 14 symbols.

In one embodiment, one slot comprises 7 symbols.

In one embodiment, one slot comprises multiple symbols.

In one embodiment, the symbol is a single carrier symbol.

In one embodiment, the symbol is a multicarrier symbol.

In one embodiment, the multicarrier symbol is an Orthogonal Frequency Division Multiplexing (OFDM) symbol.

In one embodiment, the multicarrier symbol is a Single Carrier-Frequency Division Multiple Access (SC-FDMA) symbol.

In one embodiment, the multicarrier symbol is a Discrete Fourier Transform Spread OFDM (DFT-S-OFDM) symbol.

In one embodiment, the multi-carrier symbol is a Filter Bank Multi-Carrier (FBMC) symbol.

In one embodiment, the multicarrier symbol comprises a Cyclic Prefix (CP).

### Embodiment 9

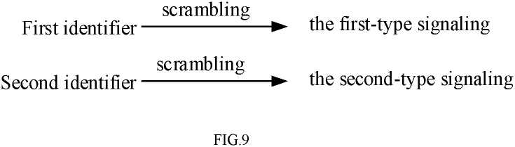

Embodiment 9 illustrates a schematic diagram of a first-type signaling and a second-type signaling according to one embodiment of the present application, as shown in FIG. 9.

In embodiment 9, the first-type signaling is scrambled by a first identifier, the second-type is scrambled by a second identifier, and the first identifier is different from the second identifier.

In one embodiment, a signal scheduled by the first-type signaling is scrambled by a first identifier, a signal scheduled by the second-type is scrambled by a second identifier, and the first identifier is different from the second identifier.

In one embodiment, the meaning of the phrase of “a given signaling being scrambled by a given identifier” comprises: a CRC of the given signaling is scrambled by the given identifier.

In one embodiment, the meaning of the phrase of “a given signaling being scrambled by a given identifier” comprises: the given identifier is used to generate a scrambling sequence of the given signaling.

In one embodiment, the meaning of the phrase of “a given signaling being scrambled by a given identifier” comprises: the given identifier is used to generate a scrambling sequence of the given signaling.

In one embodiment, the meaning of the phrase of “a given signaling being scrambled by a given identifier” comprises: the given identifier is used to generate an initial sequence of a scrambling sequence generator of the given signaling.

In one embodiment, the meaning of the phrase of “a given signaling being scrambled by a given identifier” comprises: the given identifier is n_{RNTI}, n_{RNTI} is used to generate cᵢₙᵢₜ, and a scrambling sequence generator generating a scrambling sequence of the given signaling is initialized by cᵢₙᵢₜ.

In one subembodiment of the above embodiment, cᵢₙᵢₜ = (n_{RNTI} ▪ 2¹⁶ + n_{ID})mod 2³¹.

In one subembodiment of the above embodiment, cᵢₙᵢₜ and n_{RNTI} are in a functional relation.

In one subembodiment of the above embodiment, for the specific definition of the n_{RNTI} and cᵢₙᵢₜ, refer to section 7.3.2.3 in 3GPP TS38.211.

In one embodiment, the given signaling is the first-type signaling, and the given identifier is the first identifier; or, the given signaling is the second-type signaling, and the given identifier is the second identifier.

In one embodiment, the first identifier is a UE group-common Radio network temporary identifier (RNTI), and the second identifier is a UE-specific RNTI.

In one embodiment, the first identifier is a Group configured scheduling RNTI (G-CS-RNTI), and the second identifier is a Configured Scheduling (CS)-RNTI.

In one embodiment, the first identifier is a Group RNTI (G-RNTI), and the second identifier is a Cell-RNTI (C-RNTI).

In one embodiment, the first identifier is a Group configured scheduling RNTI (G-CS-RNTI) or a Group RNTI (G-RNTI), and the second identifier is one of a C-RNTI, a Configured Scheduling (CS)-RNTI, or a Modulation and Coding Scheme (MCS)-C-RNTI.

Typically, the first identifier and the second identifier are different non-negative integers.

Typically, names of both the first identifier and the second identifier comprise RNTI.

In one embodiment, the first identifier is used to scramble a non-unicast PDSCH and a non-unicast PDCCH, and the second identifier is used to scramble a unicast PDSCH and a unicast PDCCH.

In one embodiment, the meaning of the phrase of “a given signal being scrambled by a given identifier” comprises: the given identifier is used to generate a scrambling sequence of the given signal.

In one embodiment, the meaning of the phrase of “a given signal being scrambled by a given identifier” comprises: the given identifier is used to generate a scrambling sequence of the given signal.

In one embodiment, the meaning of the phrase of “a given signal being scrambled by a given identifier” comprises: the given identifier is used to generate an initial sequence of a scrambling sequence generator of the given signal.

In one embodiment, the meaning of the phrase of “a given signal being scrambled by a given identifier” comprises: the given identifier is n_{RNTI}, the n_{RNTI} is used to generate cᵢₙᵢₜ, and a scrambling sequence generator generating a scrambling sequence of the given signal is initialized by the cᵢₙᵢₜ.

In one subembodiment of the above embodiment, cᵢₙᵢₜ = n_{RNTI} ▪ 2¹⁵ + q ▪ 2¹⁴ + n_{ID}.

In one subembodiment of the above embodiment, cᵢₙᵢₜ is linearly correlated with n_{RNTI.}

In one subembodiment of the above embodiment, cᵢₙᵢₜ and n_{RNTI} are in a functional relation.

In one subembodiment of the above embodiment, for the specific definition of the n_{RNTI} and cᵢₙᵢₜ, refer to section 7. 3. 1. 1 in 3GPP TS38. 211.

In one embodiment, the given signal is a signal scheduled by the first-type signaling, and the given identifier is the first identifier; or, the given signal is a signal scheduled by the second-type signal, and the given identifier is the second identifier.

### Embodiment 10

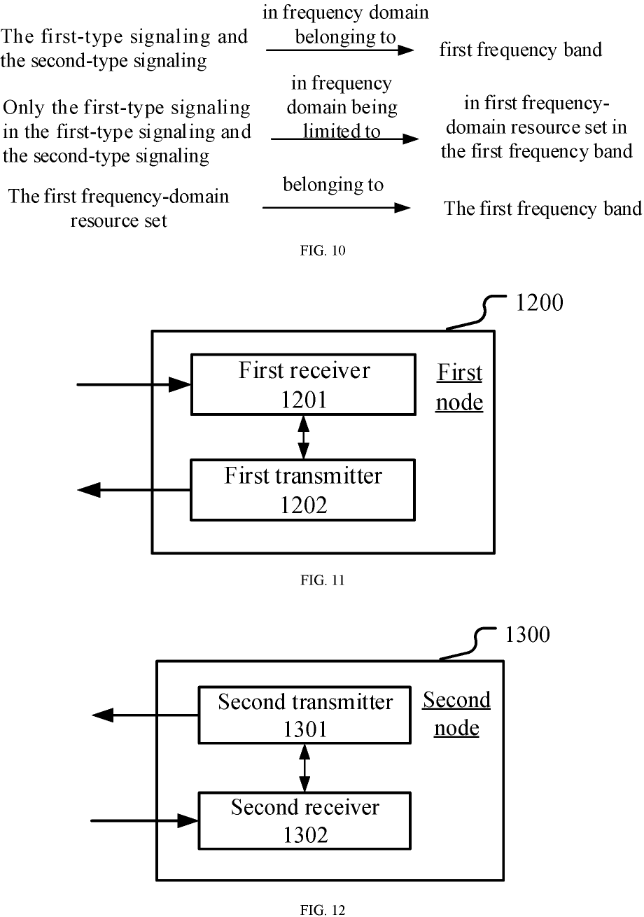

Embodiment 10 illustrates a schematic diagram of a first-type signaling and a second-type signaling according to another embodiment of the present application, as shown in FIG. 10.

In embodiment 10, both the first-type signaling and the second-type signaling belong to a first frequency band in frequency domain, only the first-type signaling in the first-type signaling and the second-type signaling is limited in a first frequency-domain resource set in the first frequency band in frequency domain, and the first frequency-domain resource set belongs to the first frequency band.

Typically, a value range of a Frequency domain resource assignment field in the second-type signaling comprises the first frequency band, and a value range of a Frequency domain resource assignment field in the first-type signaling comprises only the first frequency-domain resource set in the first frequency band.

Typically, only a signal scheduled by the first-type signaling in a signal scheduled by the first-type signaling and a signal scheduled by the second-type signal is limited in the first frequency-domain resource set in the first frequency band.

In one embodiment, the first frequency band is a Bandwidth part (BWP), and the first frequency-domain resource set comprises partial or all RBs in the first frequency band.

In one embodiment, the first frequency band is a carrier, and the first frequency-domain resource set comprises partial or all RBs in the first frequency band.

In one embodiment, the first frequency band comprises at least one RB, and the first frequency-domain resource set comprises partial or all RBs in the first frequency band.

In one embodiment, the first frequency-domain resource set is configured by a higher-layer parameter.

In one embodiment, the first frequency-domain resource set is configured by a cfr-Config-Multicast parameter.

In one embodiment, the first frequency band is a DownLink (DL) BWP, and the first frequency-domain resource set comprises common frequency resources in the first frequency band.

In one embodiment, the first frequency band is a DL BWP, and the first frequency-domain resource set comprises Multicast Broadcast Services (MBS) frequency-domain resources in the first frequency band.

In one embodiment, both the first-type signaling and the second-type signaling belong to the first frequency band in frequency domain, only the second-type signaling in the first-type signaling and the second-type signaling is limited in a first frequency-domain resource set in the first frequency band in frequency domain, and the first frequency-domain resource set belongs to the first frequency band.

Typically, the meaning of the phrase of “being limited in a first frequency-domain resource set in the first frequency band in frequency domain” refers to: belong to only first frequency-domain resource set in the first frequency band in frequency domain.

Typically, the meaning of the phrase of “being limited in a first frequency-domain resource set in the first frequency band in frequency domain” refers to: not comprising frequency-domain resources other than a first frequency-domain resource set in the first frequency band in frequency domain.

### Embodiment 11

Embodiment 11 illustrates a structure block diagram of a processor in a first node according to one embodiment of the present application, as shown in FIG. 11. In FIG. 11, a processor 1200 in a first node comprises a first receiver 1201 and a first transmitter 1202.

In one embodiment, the first node is a UE.

In one embodiment, the first node is a relay node.

In one embodiment, the first receiver 1201 comprises at least one of the antenna 452, the receiver 454, the receiving processor 456, the multi-antenna receiving processor 458, the controller/processor 459, the memory 460, or the data source 467 in Embodiment 4.

In one embodiment, the first transmitter 1202 comprises at least one of the antenna 452, the transmitter 454, the transmitting processor 468, the multi-antenna transmitting processor 457, the controller/processor 459, the memory 460, or the data source 467 in Embodiment 4.

The first receiver 1201 receives a second signaling; and

the first transmitter 1202 transmits a second bit set in a second time-frequency resource block;

In embodiment 11, the second signaling indicates the second time-frequency resource block; the second signaling is used to determine a first time-frequency resource block, the first time-frequency resource block is reserved for a first bit set, and the first bit set comprises at least one bit block; the second signaling is a first-type signaling or a second-type signaling; whether the second bit set comprises the first bit set is at least related to whether the second signaling is the first-type signaling or the second-type signaling; when the second signaling is the second-type signaling, the second bit set comprises the first bit set; when the second signaling is the first-type signaling, whether the second bit set comprises the first bit set is related to whether there exists a bit block in the first bit set comprising a HARQ-ACK associated with the second-type signaling; the bit block comprises at least one bit.

In one embodiment, when the second signaling is the first-type signaling and there does not exist a bit block in the first bit set comprising a HARQ-ACK associated with the second-type signaling, the second bit set comprises the first bit set; when the second signaling is the first-type signaling and there exists a bit block in the first bit set comprising a HARQ-ACK associated with the second-type signaling, the second bit set does not comprise any bit block in the first bit set.

In one embodiment, when the second signaling is the first-type signaling and there does not exist a bit block in the first bit set comprising a HARQ-ACK associated with the second-type signaling, the second bit set comprises the first bit set; when the second signaling is the first-type signaling and there exists a bit block in the first bit set comprising a HARQ-ACK associated with the second-type signaling, the second bit set comprises a bit block in the first bit set only comprising a HARQ-ACK associated with the first-type signaling.

In one embodiment, the first receiver 1201 receives a third signaling; receives a first signaling; and herein, the first signaling indicates the first time-frequency resource block; the first signaling is the second-type signaling, and the third signaling is the first-type signaling; the first bit set comprises multiple bit blocks; two bit blocks in the first bit set respectively comprise a HARQ-ACK associated with the first signaling and a HARQ-ACK associated with a third signaling.

In one embodiment, the second signaling indicates a first time offset, the first time offset and a slot to which the second signaling belongs in time domain are used together to determine a first slot, and the first slot is a slot to which the first time-frequency resource block belongs in time domain.

In one embodiment, the first-type signaling is scrambled by a first identifier, the second-type is scrambled by a second identifier, and the first identifier is different from the second identifier.

In one embodiment, both the first-type signaling and the second-type signaling belong to a first frequency band in frequency domain, only the first-type signaling in the first-type signaling and the second-type signaling is limited in a first frequency-domain resource set in the first frequency band in frequency domain, and the first frequency-domain resource set belongs to the first frequency band.

### Embodiment 12

Embodiment 12 illustrates a structure block diagram of a processor in a second node according to one embodiment of the present application, as shown in FIG. 12. In FIG. 12, a processor 1300 in a second node comprises a second transmitter 1301 and a second receiver 1302.

In one embodiment, the second node is a base station.

In one embodiment, the second node is a relay node.

In one embodiment, the second transmitter 1301 comprises at least one of the antenna 420, the transmitter 418, the transmitting processor 416, the multi-antenna transmitting processor 471, the controller/processor 475, or the memory 476 in Embodiment 4.

In one embodiment, the second receiver 1302 comprises at least one of the antenna 420, the receiver 418, the receiving processor 470, the multi-antenna receiving processor 472, the controller/processor 475, the memory 476 in Embodiment 4.
the second transmitter 1301 transmits a second signaling; and
the second receiver 1302 receives a second bit set in a second time-frequency resource block;
In embodiment 12, the second signaling indicates the second time-frequency resource block; the second signaling is used to determine a first time-frequency resource block, the first time-frequency resource block is reserved for a first bit set, and the first bit set comprises at least one bit block; the second signaling is a first-type signaling or a second-type signaling; whether the second bit set comprises the first bit set is at least related to whether the second signaling is the first-type signaling or the second-type signaling; when the second signaling is the second-type signaling, the second bit set comprises the first bit set; when the second signaling is the first-type signaling, whether the second bit set comprises the first bit set is related to whether there exists a bit block in the first bit set comprising a HARQ-ACK associated with the second-type signaling; the bit block comprises at least one bit.

In one embodiment, when the second signaling is the first-type signaling and there does not exist a bit block in the first bit set comprising a HARQ-ACK associated with the second-type signaling, the second bit set comprises the first bit set; when the second signaling is the first-type signaling and there exists a bit block in the first bit set comprising a HARQ-ACK associated with the second-type signaling, the second bit set does not comprise any bit block in the first bit set.

In one embodiment, when the second signaling is the first-type signaling and there does not exist a bit block in the first bit set comprising a HARQ-ACK associated with the second-type signaling, the second bit set comprises the first bit set; when the second signaling is the first-type signaling and there exists a bit block in the first bit set comprising a HARQ-ACK associated with the second-type signaling, the second bit set comprises a bit block in the first bit set only comprising a HARQ-ACK associated with the first-type signaling.

In one embodiment, the second transmitter 1301 transmits a third signaling; transmits a first signaling; herein, the first signaling indicates the first time-frequency resource block; the first signaling is the second-type signaling, and the third signaling is the first-type signaling; the first bit set comprises multiple bit blocks; two bit blocks in the first bit set respectively comprise a HARQ-ACK associated with the first signaling and a HARQ-ACK associated with a third signaling.

In one embodiment, the second signaling indicates a first time offset, the first time offset and a slot to which the second signaling belongs in time domain are used together to determine a first slot, and the first slot is a slot to which the first time-frequency resource block belongs in time domain.

In one embodiment, the first-type signaling is scrambled by a first identifier, the second-type is scrambled by a second identifier, and the first identifier is different from the second identifier.

In one embodiment, both the first-type signaling and the second-type signaling belong to a first frequency band in frequency domain, only the first-type signaling in the first-type signaling and the second-type signaling is limited in a first frequency-domain resource set in the first frequency band in frequency domain, and the first frequency-domain resource set belongs to the first frequency band.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The user equipment, terminal and UE include but are not limited to Unmanned Aerial Vehicles (UAVs), communication modules on UAVs, tele-controlled aircrafts, aircrafts, diminutive airplanes, mobile phones, tablet computers, notebooks, vehicle-mounted communication equipment, wireless sensors, network cards, Internet of Things (IoT) terminals, RFID terminals, NB-IOT terminals, Machine Type Communication (MTC) terminals, enhanced MTC (eMTC) terminals, data card, network cards, vehicle-mounted communication equipment, low-cost mobile phones, low-cost tablets and other wireless communication devices. The UE and terminal in the present application include but not limited to unmanned aerial vehicles, communication modules on unmanned aerial vehicles, tele-controlled aircrafts, aircrafts, diminutive airplanes, mobile phones, tablet computers, notebooks, vehicle-mounted communication equipment, wireless sensor, network cards, terminals for Internet of Things, RFID terminals, NB-IOT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

The above are merely the preferred embodiments of the present application and are not intended to limit the scope of protection of the present application. Any changes and modifications made based on the embodiments described in the specification that can achieve similar partial or total technical effects shall be deemed obvious and fall within the scope of protection of the present invention.

What is claimed is:

1. A first node for wireless communications, comprising:
a first receiver, receiving a second signaling; and
a first transmitter, transmitting a second bit set in a second time-frequency resource block;
wherein the second signaling indicates the second time-frequency resource block; the second signaling is used to determine a first time-frequency resource block, the first time-frequency resource block is reserved for a first bit set, and the first bit set comprises at least one bit block; the second signaling is a first-type signaling or a second-type signaling; whether the second bit set comprises the first bit set is at least related to whether the second signaling is the first-type signaling or the second-type signaling; when the second signaling is the second-type signaling, the second bit set comprises the first bit set; when the second signaling is the first-type signaling, whether the second bit set comprises the first bit set is related to whether there exists a bit block in the first bit set comprising a Hybrid Automatic Repeat reQuest -ACK (HARQ-ACK) associated with the second-type signaling; the bit block comprises at least one bit.

2. The first node according to claim 1, wherein when the second signaling is the first-type signaling and there does not exist a bit block in the first bit set comprising a HARQ-ACK associated with the second-type signaling, the second bit set comprises the first bit set; when the second signaling is the first-type signaling and there exists a bit block in the first bit set comprising a HARQ-ACK associated with the second-type signaling, the second bit set does not comprise any bit block in the first bit set.

3. The first node according to claim 1, wherein when the second signaling is the first-type signaling and there does not exist a bit block in the first bit set comprising a HARQ-ACK associated with the second-type signaling, the second bit set comprises the first bit set; when the second signaling is the first-type signaling and there exists a bit block in the first bit set comprising a HARQ-ACK associated with the second-type signaling, the second bit set comprises a bit block in the first bit set only comprising a HARQ-ACK associated with the first-type signaling.

4. The first node according to claim 1, wherein the first receiver receives a third signaling; receives a first signaling; wherein the first signaling indicates the first time-frequency resource block; the first signaling is the second-type signaling, and the third signaling is the first-type signaling; the first bit set comprises multiple bit blocks; two bit blocks in the first bit set respectively comprise a HARQ-ACK associated with the first signaling and a HARQ-ACK associated with a third signaling;
or, the second signaling indicates a first time offset, the first time offset and a slot to which the second signaling belongs in time domain are used together to determine a first slot, and the first slot is a slot to which the first time-frequency resource block belongs in time domain;
or, the first-type signaling is scrambled by a first identifier, the second-type is scrambled by a second identifier, and the first identifier is different from the second identifier.

5. The first node according to claim 1, wherein both the first-type signaling and the second-type signaling belong to a first frequency band in frequency domain, only the first-type signaling in the first-type signaling and the second-type signaling is limited in a first frequency-domain resource set in the first frequency band in frequency domain, and the first frequency-domain resource set belongs to the first frequency band.

6. A second node for wireless communications, comprising:
a second transmitter, transmitting a second signaling; and
a second receiver, receiving a second bit set in a second time-frequency resource block;
wherein the second signaling indicates the second time-frequency resource block; the second signaling is used to determine a first time-frequency resource block, the first time-frequency resource block is reserved for a first bit set, and the first bit set comprises at least one bit block; the second signaling is a first-type signaling or a second-type signaling; whether the second bit set comprises the first bit set is at least related to whether the second signaling is the first-type signaling or the second-type signaling; when the second signaling is the second-type signaling, the second bit set comprises the first bit set; when the second signaling is the first-type signaling, whether the second bit set comprises the first bit set is related to whether there exists a bit block in the first bit set comprising a HARQ-ACK associated with the second-type signaling; the bit block comprises at least one bit.

7. The second node according to claim 1, wherein when the second signaling is the first-type signaling and there does not exist a bit block in the first bit set comprising a HARQ-ACK associated with the second-type signaling, the second bit set comprises the first bit set; when the second signaling is the first-type signaling and there exists a bit block in the first bit set comprising a HARQ-ACK associated with the second-type signaling, the second bit set does not comprise any bit block in the first bit set.

8. The second node according to claim 1, wherein when the second signaling is the first-type signaling and there does not exist a bit block in the first bit set comprising a HARQ-ACK associated with the second-type signaling, the second bit set comprises the first bit set; when the second signaling is the first-type signaling and there exists a bit block in the first bit set comprising a HARQ-ACK associated with the second-type signaling, the second bit set comprises a bit block in the first bit set only comprising a HARQ-ACK associated with the first-type signaling.

9. The second node according to claim 1, wherein the second transmitter transmits a third signaling; transmits a first signaling; wherein the first signaling indicates the first time-frequency resource block; the first signaling is the second-type signaling, and the third signaling is the first-type signaling; the first bit set comprises multiple bit blocks; two bit blocks in the first bit set respectively comprise a HARQ-ACK associated with the first signaling and a HARQ-ACK associated with a third signaling;
or, the second signaling indicates a first time offset, the first time offset and a slot to which the second signaling belongs in time domain are used together to determine a first slot, and the first slot is a slot to which the first time-frequency resource block belongs in time domain;
or, the first-type signaling is scrambled by a first identifier, the second-type is scrambled by a second identifier, and the first identifier is different from the second identifier.

10. The second node according to claim 1, wherein both the first-type signaling and the second-type signaling belong to a first frequency band in frequency domain, only the first-type signaling in the first-type signaling and the second-type signaling is limited in a first frequency-domain resource set in the first frequency band in frequency domain, and the first frequency-domain resource set belongs to the first frequency band.

11. A method in a first node for wireless communications, comprising:
receiving a second signaling; and
transmitting a second bit set in a second time-frequency resource block;
wherein the second signaling indicates the second time-frequency resource block; the second signaling is used to determine a first time-frequency resource block, the first time-frequency resource block is reserved for a first bit set, and the first bit set comprises at least one bit block; the second signaling is a first-type signaling or a second-type signaling; whether the second bit set comprises the first bit set is at least related to whether the second signaling is the first-type signaling or the second-type signaling; when the second signaling is the second-type signaling, the second bit set comprises the first bit set; when the second signaling is the first-type signaling, whether the second bit set comprises the first bit set is related to whether there exists a bit block in the first bit set comprising a HARQ-ACK associated with the second-type signaling; the bit block comprises at least one bit.

12. The method according to claim 11, wherein when the second signaling is the first-type signaling and there does not exist a bit block in the first bit set comprising a HARQ-ACK associated with the second-type signaling, the second bit set comprises the first bit set; when the second signaling is the first-type signaling and there exists a bit block in the first bit set comprising a HARQ-ACK associated with the second-type signaling, the second bit set does not comprise any bit block in the first bit set.

13. The method according to claim 11, wherein when the second signaling is the first-type signaling and there does not exist a bit block in the first bit set comprising a HARQ-ACK associated with the second-type signaling, the second bit set comprises the first bit set; when the second signaling is the first-type signaling and there exists a bit block in the first bit set comprising a HARQ-ACK associated with the second-type signaling, the second bit set comprises a bit block in the first bit set only comprising a HARQ-ACK associated with the first-type signaling.

14. The method according to claim 11, comprising:
receiving a third signaling; and receiving a first signaling; wherein the first signaling indicates the first time-frequency resource block; the first signaling is the second-type signaling, and the third signaling is the first-type signaling; the first bit set comprises multiple bit blocks; two bit blocks in the first bit set respectively comprise a HARQ-ACK associated with the first signaling and a HARQ-ACK associated with a third signaling;
or, the second signaling indicates a first time offset, the first time offset and a slot to which the second signaling belongs in time domain are used together to determine a first slot, and the first slot is a slot to which the first time-frequency resource block belongs in time domain;
or, the first-type signaling is scrambled by a first identifier, the second-type is scrambled by a second identifier, and the first identifier is different from the second identifier.

15. The method according to claim 11, wherein both the first-type signaling and the second-type signaling belong to a first frequency band in frequency domain, only the first-type signaling in the first-type signaling and the second-type signaling is limited in a first frequency-domain resource set in the first frequency band in frequency domain, and the first frequency-domain resource set belongs to the first frequency band.

16. A method in a second node for wireless communications, comprising:
transmitting a second signaling; and
receiving a second bit set in a second time-frequency resource block;
wherein the second signaling indicates the second time-frequency resource block; the second signaling is used to determine a first time-frequency resource block, the first time-frequency resource block is reserved for a first bit set, and the first bit set comprises at least one bit block; the second signaling is a first-type signaling or a second-type signaling; whether the second bit set comprises the first bit set is at least related to whether the second signaling is the first-type signaling or the second-type signaling; when the second signaling is the second-type signaling, the second bit set comprises the first bit set; when the second signaling is the first-type signaling, whether the second bit set comprises the first bit set is related to whether there exists a bit block in the first bit set comprising a HARQ-ACK associated with the second-type signaling; the bit block comprises at least one bit.

17. The method according to claim 16, wherein when the second signaling is the first-type signaling and there does not exist a bit block in the first bit set comprising a HARQ-ACK associated with the second-type signaling, the second bit set comprises the first bit set; when the second signaling is the first-type signaling and there exists a bit block in the first bit set comprising a HARQ-ACK associated with the second-type signaling, the second bit set does not comprise any bit block in the first bit set.

18. The method according to claim 16, wherein when the second signaling is the first-type signaling and there does not exist a bit block in the first bit set comprising a HARQ-ACK associated with the second-type signaling, the second bit set comprises the first bit set; when the second signaling is the first-type signaling and there exists a bit block in the first bit set comprising a HARQ-ACK associated with the second-type signaling, the second bit set comprises a bit block in the first bit set only comprising a HARQ-ACK associated with the first-type signaling.

19. The method according to claim 16, comprising:
transmitting a third signaling; transmitting a first signaling; wherein the first signaling indicates the first time-frequency resource block; the first signaling is the second-type signaling, and the third signaling is the first-type signaling; the first bit set comprises multiple bit blocks; two bit blocks in the first bit set respectively comprise a HARQ-ACK associated with the first signaling and a HARQ-ACK associated with a third signaling;
or, the second signaling indicates a first time offset, the first time offset and a slot to which the second signaling belongs in time domain are used together to determine a first slot, and the first slot is a slot to which the first time-frequency resource block belongs in time domain;
or, the first-type signaling is scrambled by a first identifier, the second-type is scrambled by a second identifier, and the first identifier is different from the second identifier.

20. The method according to claim 16, wherein both the first-type signaling and the second-type signaling belong to a first frequency band in frequency domain, only the first-type signaling in the first-type signaling and the second-type signaling is limited in a first frequency-domain resource set in the first frequency band in frequency domain, and the first frequency-domain resource set belongs to the first frequency band.
